(19) United States
(12) Patent Application Publication
(10) Pub. No.: US 2025/0227527 A1
(43) Pub. Date: Jul. 10, 2025

(54) ADAPTIVE MEASUREMENT PROCEDURE FOR INTERMITTED AND OVERLAPPING NON-TERRESTRIAL NETWORK COVERAGE

(71) Applicant: Telefonaktiebolaget LM Ericsson (publ), Stockholm (SE)

(72) Inventors: Ming LI, Stockholm (SE); Helka-Liina MÄÄTTÄNEN, Espoo (FI); Muhammad Ali KAZMI, Sundbyberg (SE)

(21) Appl. No.: 18/683,928

(22) PCT Filed: Aug. 12, 2022
(86) PCT No.: PCT/SE2022/050749

§ 371 Date: Feb. 15, 2024

Related U.S. Application Data
(60) Provisional application No. 63/233,525, filed on Aug. 16, 2021.

(51) Int. Cl. H04W 24/10; H04B 7/185

(52) U.S. Cl. CPC H04W 24/10; H04B 7/18539; H04B 7/18554

(57) ABSTRACT

A method, network node and wireless device (WD) for performing adaptive measurement procedures for intermitted and overlapping non-terrestrial network (NTN) coverage are disclosed. According to one aspect, a method in a WD includes determining a satellite coverage time based at least in part on the ephemeris data. The method also includes performing a first measurement procedure to measure satellite signals during a first measurement time when the satellite coverage time is less than a first threshold. The method further includes performing a second measurement procedure to measure satellite signals during a second measurement time when the satellite coverage time is greater than a second threshold.

### TECHNICAL FIELD

The present disclosure relates to wireless communications, and in particular, to adaptive measurement procedures for intermitted and overlapping non-terrestrial network (NTN) coverage.

### BACKGROUND

Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

There is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting the terrestrial wireless access technologies including LTE and NR for satellite networks is drawing significant interest, which has been reflected in the 3GPP standardization work.

In 3GPP Technical Release 15 (3GPP Rel-15), the first release of the 5G system (5GS) was specified. This is a radio access technology intended to serve use cases such as enhanced mobile broadband (eMBB), ultra-reliable and low latency communication (URLLC), and massive machine type communication (mMTC). 5G includes the New Radio (NR) access stratum interface and the 5G Core Network (5GC). The NR physical layer and higher layers are reusing parts of the 3GPP LTE specification. Also, components are being added when motivated by new use cases. One such component is the introduction of a sophisticated framework for beam forming and beam management to extend the support of the 3GPP technologies to a frequency range going beyond 6 GHz.

In 3GPP Rel-15, the 3GPP began work to prepare NR for operation in a Non-Terrestrial Network (NTN). The work was performed within the study item “NR to support Non-Terrestrial Networks” and resulted in 3GPP Technical Release (TR) 38.811 [1]. In 3GPP Rel-16, work to prepare NR for operation in an NTN network continued with the study item “Solutions for NR to support Non-Terrestrial Network.” In parallel, the interest to adapt narrow band Internet of things (NB-IoT) and LTE-machines (LTE-M) for operation in an NTN is growing. As a consequence, 3GPP Release 17 contains both a work item on NR NTN and a study item on NB-IoT and LTE-M support for NTN.

### Characteristics

A satellite radio access network usually includes the following components:
A satellite that refers to a space-borne platform;
An earth-based gateway that connects the satellite to a base station or a core network, depending on the choice of architecture;
A feeder link that refers to the link between a gateway and a satellite; and/or
An access link, or service link, that refers to the link between a satellite and a WD.

A satellite may be categorized as low earth orbit (LEO), medium earth orbit (MEO), or geostationary earth orbit (GEO) satellite, as follows:
LEO: typical heights ranging from 250-1,500 km, with orbital periods ranging from 90-120 minutes;
MEO: typical heights ranging from 5,000-25,000 km, with orbital periods ranging from 3-15 hours; and
GEO: height at about 35,786 km, with an orbital period of 24 hours.

Two basic architectures can be distinguished for satellite communication networks, depending on the functionality of the satellites in the system:
(1). Transparent payload (also referred to as bent pipe architecture). The satellite forwards the received signal between the terminal and the network equipment on the ground with only amplification and a shift from uplink frequency to downlink frequency. When applied to general 3GPP architecture and terminology, the transparent payload architecture means that the gNB is located on the ground and the satellite forwards signals/data between the gNB and the WD
(2). Regenerative payload. The satellite includes on-board processing to demodulate and decode the received signal and regenerate the signal before sending it back to the earth. When applied to general 3GPP architecture and terminology, the regenerative payload architecture means that the gNB is located in the satellite.

In the work item for NR NTN in 3GPP Release-17, only the transparent payload architecture is considered.

A satellite network or satellite based mobile network may also be called a non-terrestrial network (NTN). On the other hand, a mobile network with base stations on the ground may be called a terrestrial network (TN) or non-NTN network. A satellite within a NTN may be called a NTN node, NTN satellite or simply a satellite.

FIG. 1 shows an example architecture of a satellite network with bent pipe transponders (i.e., the transparent payload architecture). A communication satellite typically generates several beams over a given area. The footprint of a beam is usually in an elliptic shape, which has traditionally been considered as a cell, but cells consisting of the coverage footprint of multiple beams are not excluded in 3GPP standardization work. The footprint of a beam is also often referred to as a spotbeam. The footprint of a beam may move over the earth's surface with the satellite movement or may be earth fixed with a beam pointing mechanism used by the satellite to compensate for the satellite's motion. The size of a spotbeam depends on the system design, which may range from tens of kilometers to a few thousands of kilometers.

In a LEO or MEO communication system, a large number of satellites deployed over a range of orbits are required to provide continuous coverage across the full globe. Launching a mega satellite constellation is both an expensive and time-consuming procedure. It is therefore expected that all LEO and MEO satellite constellations for some time will only provide partial earth-coverage. In case of some constellations dedicated to massive Internet of things (IoT) services with relaxed latency requirements, it may not be necessary to support full earth-coverage. It may be sufficient to provide occasional or periodic coverage according to the orbital period of the constellation.

A 3GPP device in RRC IDLE or RRC_INACTIVE state is required to perform a number of procedures including measurements for mobility purposes, paging monitoring, logging measurement results, tracking area updates, and searching for a new Public Land Mobile Network (PLMN), to mention a few. These procedures will consume power in devices, and a general trend in the 3GPP has been to allow for relaxation of these procedures to prolong device battery life. This trend has been especially pronounced for IoT devices supported by reduced capability (redcap), NB-IoT and LTE-M.

Propagation delay is an aspect of satellite communications that is different from the delay expected in a terrestrial mobile system. For a bent pipe satellite network, the round-trip delay may, depending on the orbit height, range from tens of ms in the case of LEO satellites to several hundreds of ms for GEO satellites. As a comparison, the round-trip delays in terrestrial cellular networks are typically below 1 ms.

The distance between the WD and a satellite can vary significantly, depending on the position of the satellite and thus the elevation angle ε seen by the WD. Assuming circular orbits, the minimum distance is realized when the satellite is directly above the WD (ε=90°), and the maximum distance when the satellite is at the smallest possible elevation angle. Table 1 shows the distances between satellite and WD for different orbital heights and elevation angles together with the one-way propagation delay and the maximum propagation delay difference (the difference from the propagation delay at ε=90°). Note that this table assumes the regenerative payload architecture. For the transparent payload case, the propagation delay between gateway and satellite needs to be considered as well, unless the base station corrects for that.

TABLE 1
Propagation delay for different orbital heights and elevation angles.

| | | Distance | | One-way | | Propagation | |
|---|---|---|---|---|---|---|---|
| Orbital | Elevation | UE <−> | | propagation | | delay | |
| height | angle | satellite | | delay | | difference | |
| 600 km | 90° | 600 | km | 2.0 | ms | — | |
| | 30° | 1075 | km | 3.6 | ms | 1.6 | ms |
| | 10° | 1932 | km | 6.4 | ms | 4.4 | ms |
| 1200 km | 90° | 1200 | km | 4.0 | ms | — | |
| | 30° | 1999 | km | 6.7 | ms | 2.7 | ms |
| | 10° | 3131 | km | 10.4 | ms | 6.4 | ms |
| 35786 km | 90° | 35786 | km | 119.4 | ms | — | |
| | 30° | 38609 | km | 128.8 | ms | 9.4 | ms |
| | 10° | 40581 | km | 135.4 | ms | 16.0 | ms |

The propagation delay may also be highly variable due to the high velocity of the LEO and MEO satellites and may change on the order of 10-100 us every second, depending on the orbit altitude and satellite velocity.

### Ephemeris Data

In the 3GPP Technical Release (TR) 38.821, it has been considered that ephemeris data should be provided to the WD, for example to assist with pointing a directional antenna (or an antenna beam) towards the satellite. A WD knowing its own position, e.g., via global navigation satellite system (GNSS) support, may use the ephemeris data to calculate correct timing and/or frequency drifts, which may include determining a Timing Advance (TA) and Doppler shift. The contents of the ephemeris data and the procedures on how to provide and update such data have not been considered in detail by the 3GPP.

A satellite orbit can be fully described using 6 parameters. Exactly which set of parameters is used can be decided by the user; many different representations are possible. For example, a choice of parameters often used in astronomy is the set (α, ε, i, Ω, ω, t). Here, the semi-major axis a and the eccentricity ε describe the shape and size of the orbit ellipse; the inclination i, the right ascension of the ascending node Ω, and the argument of periapsis ω, determine position of the satellite in space; the epoch t determines a reference time (e.g., the time when the satellites moves through periapsis). The set of these parameters is illustrated in FIG. 2

A two-line element set (TLE) is a data format encoding a list of orbital elements of an Earth-orbiting object for a given point in time called the epoch. As an example of a different parametrization, TLEs use mean motion n and mean anomaly M instead of a and t.

A completely different set of parameters is the position and velocity vector (x, y, Z, vx, vy, vz) of a satellite. These are sometimes called orbital state vectors. They can be derived from the orbital elements and vice versa since the information they contain is equivalent. All these formulations (and many others) are possible choices for the format of ephemeris data to be used in NTN.

Additionally, the ephemeris data may be accompanied with information on possible coverage areas, or timing information concerning when the satellite is going to serve a certain geographical area on Earth.

The following challenges are to be addressed in NTN: moving satellites (resulting in moving cells or switching cells) and long propagation delays:
Moving satellites (resulting in moving or switching cells): The default assumption in terrestrial network design, (e.g., NR or LTE), is that cells are stationary. This is not the case in NTN, especially when LEO satellites are considered. A LEO satellite may be visible to a WD on the ground only for a few seconds or minutes. There are two different options for LEO deployment. The beam and cell coverage is fixed with respect to a geographical location with earth-fixed beams, i.e., steerable satellite beams ensure that a certain beam covers the same geographical area even as the satellite moves in relation to the surface of the earth. On the other hand, with moving beams, an LEO satellite has a fixed antenna pointing direction in relation to the earth's surface, e.g., perpendicular to the earth's surface, and thus cell/beam coverage sweeps the earth as the satellite moves. In that case, the spotbeam that serves the WD may change every few seconds; and/or
Long propagation delays: The propagation delays in terrestrial mobile systems are usually less than 1 millisecond. In contrast, the propagation delays in NTN can be much longer, ranging from several milliseconds (LEO) to hundreds of milliseconds (GEO) depending on the altitudes of the spaceborne or airborne platforms deployed in the NTN.

Depending on the deployment, there may be a large number of occurrences of occasional overlap of coverage of two or more satellites. Typically, a device camping on a network expects continuous network availability. This is in contrast to camping on a satellite network. A radio access network associated with satellites is changing, unlike the carefully designed coverage of a cell of a terrestrial network.

Long propagation delays also aggravate a WD's measurement load because measurements should cover the wide range of propagation delays from different satellites.

Essentially, ephemeris-based and timer-based mobility may mitigate these issues to some degree, resulting from acquisition of enough accurate satellite position data at any given time.

### SUMMARY

Some embodiments advantageously provide methods, network nodes, and wireless devices (WDs) for performing adaptive measurement procedures for intermitted and overlapping non-terrestrial network (NTN) coverage.

Some embodiments include a mechanism for a WD served by an NTN node to adaptively adjust measurement procedures (e.g., measurement rate, periodicity, duration, time, etc.) based on a determined sojourn time of a satellite. The sojourn time of a satellite is defined as the time period during which the satellite can provide coverage to the WD. When the coverage is provided, the WD can communicate two-way with the satellite.

According to a first embodiment, the WD obtains a coverage time of a satellite autonomously based on the WD's calculation (e.g., by using ephemeris data, etc.) or based on information received from a network node within system information (SI) for example.

According to a second embodiment, the WD has at least two or more states of measurement, a normal state and one or more relaxed states. The WD is configured to evaluate one or more criteria based on the obtained satellite coverage time. Based on the evaluation, the WD determines whether to switch from a normal measurement state to a relaxed measurement state. In the normal measurement state, the WD uses a first measurement procedure (P1) for performing the measurements and in a relaxed measurement state the WD uses a second measurement procedure (P2) for performing the measurements. While applying P1, the WD meets legacy requirements and while applying P2, the WD meets relaxed requirements. The relaxed requirements are less stringent than the legacy requirements. For example, a measurement period may be shorter for the normal state and longer in a relaxed state.

According to a third embodiment, the measurement time in the normal state and the measurement time in a relaxed time may be related by scaling factors, which can be pre-defined or configured by the network node.

According to a fourth embodiment, a network node configures the WD to operate in the normal state and a relaxed state or only in the normal state regardless of whether the WD meets criteria to enter a relaxed state. In another example, the WD may allowed to enter a relaxed state provided that the satellite coverage time is above a certain threshold and/or the remaining satellite coverage time is above a certain threshold.

Mechanisms are provided for the WD to adjust measurements in a timely manner and to spend less time performing measurements for mobility and signaling in NTN, thereby reducing power consumption and signaling overhead by the WD.

According to one aspect, a method in a wireless device, WD, configured to perform measurements on satellite signals received from a satellite is provided. The WD is configured to receive ephemeris data from at least one of the satellite and a network node. The method includes determining a satellite coverage time based at least in part on the ephemeris data. The method also includes performing a first measurement procedure to measure satellite signals during a first measurement time when the satellite coverage time is less than a first threshold. The method also includes performing a second measurement procedure to measure satellite signals during a second measurement time when the satellite coverage time is greater than a second threshold.

According to this aspect, in some embodiments, the first measurement time is determined based at least in part on scaling a base time interval by a first scaling factor and the second measurement time is determined based at least in part on scaling the base time interval by a second scaling factor, the first scaling factor being less than the second scaling factor. In some embodiments, measurements of the satellite signals are performed in a first repetition pattern during the first measurement time and measurements of the satellite signals are performed in a second repetition pattern during the second measurement time. In some embodiments, the satellite coverage time is determined based at least in part on an angle of arrival of a satellite signal. In some embodiments, at least one of the first measurement time and the second measurement time excludes at least one guard window during a time of remaining satellite coverage. In some embodiments, the satellite coverage time is based at least in part on information from the network node including at least one of WD position, WD direction, and WD speed. In some embodiments, at least one of the first measurement time and the second measurement time is based at least in part on an estimate of error in the ephemeris data. In some embodiments, the first measurement procedure includes measuring satellite signals on a first number of beams and the second measurement procedure includes measuring satellite signals on a second number of beams. In some embodiments, the first measurement procedure includes measurement on a first number of reference signals and the second measurement procedure includes measurement on a second number of reference signals. In some embodiments, the method includes sending measurement reports to the network node in a first repetition pattern during the first measurement time and sending measurement reports to the network node in a second repetition pattern during the second measurement time. In some embodiments, the first measurement time is smaller than the second time. In some embodiments, at least one of the first measurement time and the second measurement time includes at least one of a cell detection time, a measurement period of a measurement, synchronization signal block, SSB, index acquisition time, measurement reporting delay, radio link monitoring, RLM, out of sync evaluation period, RLM in sync evaluation period, beam detection evaluation period, candidate beam detection evaluation period and measurement period of L1-measurement.

According to another aspect, a wireless device, WD, configured to perform measurements on satellite signals received from a satellite is provided. WD is further configured to receive ephemeris data from at least one of the satellite and a network node. The WD includes processing circuitry configured to determine a satellite coverage time based at least in part on the ephemeris data. The processing circuitry is also configured to perform a first measurement procedure to measure satellite signals during a first measurement time when the satellite coverage time is less than a first threshold. The processing circuitry is also configured to perform a second measurement procedure to measure satellite signals during a second measurement time when the satellite coverage time is greater than a second threshold.

According to this aspect, in some embodiments, the first measurement time is determined based at least in part on scaling a base time interval by a first scaling factor and the second measurement time is determined based at least in part on scaling the base time interval by a second scaling factor, the first scaling factor being less than the second scaling factor. In some embodiments, measurements of the satellite signals are performed in a first repetition pattern during the first measurement time and measurements of the satellite signals are performed in a second repetition pattern during the second measurement time. In some embodiments, the satellite coverage time is determined based at least in part on an angle of arrival of a satellite signal. In some embodiments, at least one of the first measurement time and the second measurement time excludes at least one guard window during a remaining time of satellite coverage. In some embodiments, the satellite coverage time is based at least in part on information from the network node including at least one of WD position, WD direction, and WD speed. In some embodiments, at least one of the first measurement time and the second measurement time is based at least in part on an estimate of error in the ephemeris data. In some embodiments, the first measurement procedure includes measuring satellite signals on a first number of beams and the second measurement procedure includes measuring satellite signals on a second number of beams. In some embodiments, the first measurement procedure includes measurement on a first number of reference signals and the second measurement procedure includes measurement on a second number of reference signals. In some embodiments, the WD also includes a radio interface in communication with the processing circuitry and configured to send measurement reports to the network node in a first repetition pattern during the first measurement time and send measurement reports to the network node in a second repetition pattern during the second measurement time. In some embodiments, the first measurement time is smaller than the second time. In some embodiments, at least one of the first measurement time and the second measurement time includes at least one of a cell detection time, a measurement period of a measurement, synchronization signal block, SSB, index acquisition time, measurement reporting delay, radio link monitoring, RLM, out of sync evaluation period, RLM in sync evaluation period, beam detection evaluation period, candidate beam detection evaluation period and measurement period of L1-measurement.

According to another aspect, a method in a network node configured to communicate with a satellite and a wireless device, WD, is provided. The method includes determining a satellite coverage time based at least in part on ephemeris data from the satellite. The method also includes configuring the WD to perform a first measurement procedure to measure satellite signals during a first measurement time when the satellite coverage time is less than a first threshold and to perform a second measurement procedure to measure satellite signals during a second measurement time when the satellite coverage time is greater than a second threshold.

According to this aspect, in some embodiments, the first measurement time is determined based at least in part on scaling a base time interval by a first scaling factor and the second measurement time is determined based at least in part on scaling the base time interval by a second scaling factor, the first scaling factor being less than the second scaling factor. In some embodiments, the satellite coverage time is determined based at least in part on an angle of arrival of a satellite signal at the WD. In some embodiments, the method also includes determining a plurality of satellite coverage times based at least in part on ephemeris data from a plurality of satellites and configuring the WD with a first satellite coverage time of the plurality of satellite coverage times. In some embodiments, the first measurement time is smaller than the second measurement time. In some embodiments, the first measurement time or the second measurement time comprising at least one of a cell detection time, a measurement period of a measurement, synchronization signal block, SSB, index acquisition time, measurement reporting delay, radio link monitoring, RLM, out of sync measurement time, RLM in sync measurement time, beam detection measurement time, candidate beam detection measurement time and measurement period of L1-measurement.

According to yet another aspect, a network node configured to communicate with a satellite and a wireless device, WD, is provided. The network node includes processing circuitry configured to: determine a satellite coverage time based at least in part on ephemeris data from the satellite; and configure the WD to perform a first measurement procedure to measure satellite signals during a first measurement time when the satellite coverage time is less than a first threshold and to perform a second measurement procedure to measure satellite signals during a second measurement time when the satellite coverage time is greater than a second threshold.

According to this aspect, in some embodiments, the first measurement time is determined based at least in part on scaling a base time interval by a first scaling factor and the second measurement time is determined based at least in part on scaling the base time interval by a second scaling factor, the first scaling factor being less than the second scaling factor. In some embodiments, the processing circuitry is further configured to configure the WD to perform measurements of the satellite signals in a first repetition pattern during the first measurement time and to perform measurement of the satellite signals in a second repetition pattern during the second measurement time. In some embodiments, the satellite coverage time is determined based at least in part on an angle of arrival of a satellite signal at the WD. In some embodiments, the processing circuitry is further configured to determine a plurality of satellite coverage times based at least in part on ephemeris data from a plurality of satellites and to configure the WD with a first satellite coverage time of the plurality of satellite coverage times. In some embodiments, the first measurement time is smaller than the second measurement time. In some embodiments, at least one of the first measurement time and the second measurement time comprising at least one of a cell detection time, a measurement period of a measurement, synchronization signal block, SSB, index acquisition time, measurement reporting delay, radio link monitoring, RLM, out of sync measurement time, RLM in sync measurement time, beam detection measurement time, candidate beam detection measurement time and measurement period of L1-measurement.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example NTN with bent pipe transponders;

FIG. 2 illustrates orbital elements;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for performing adaptive measurement procedures for intermitted and overlapping non-terrestrial network (NTN) coverage according to some embodiments of the present disclosure;

FIG. 10 is a flowchart of an example process in a wireless device for performing adaptive measurement procedures for intermitted and overlapping non-terrestrial network (NTN) coverage according to some embodiments of the present disclosure;

FIG. 11 is a flowchart of another example process in a wireless device for performing adaptive measurement procedures for intermitted and overlapping non-terrestrial network (NTN) coverage according to some embodiments of the present disclosures;

FIG. 12 is a flowchart of another example process in a network node for performing adaptive measurement procedures for intermitted and overlapping non-terrestrial network (NTN) coverage according to some embodiments of the present disclosure;

FIG. 13 illustrates an example of different coverage times of satellites;

FIG. 14 illustrates an example of satellite connections;

FIG. 15 illustrates an alternative embodiment of satellite connections as compared to the satellite connections shown in FIG. 12;

FIG. 16 illustrates an example of a satellite observed by a WD;

FIG. 17 illustrates an example of coverage times;

FIG. 18 illustrates an example of coverage times for each of a plurality of satellites; and

FIG. 19 illustrates an example of a set of coverage times.

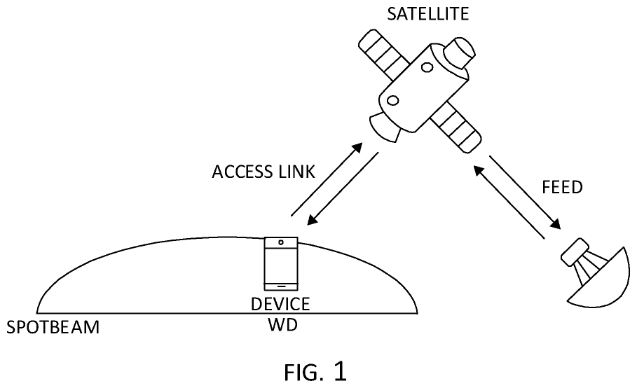

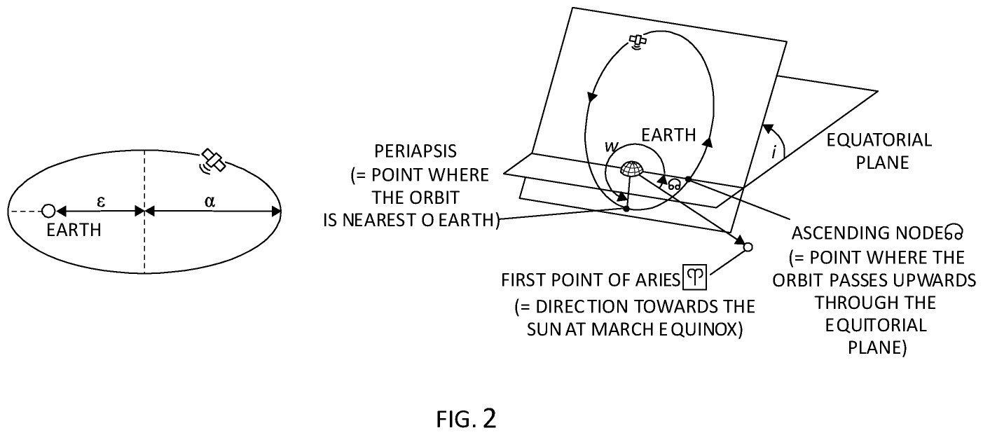

### DETAILED DESCRIPTION

Before describing in detail example embodiments, it is noted that the embodiments reside primarily in combinations of apparatus components and processing steps related to adaptive measurement procedures for intermitted and overlapping non-terrestrial network (NTN) coverage. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices. Also, when reference is made to a network node transmitting to a particular wireless device, it will be understood that unless otherwise noted, the signal transmitted to the particular wireless device may be broadcast by the network node over a geographical area that encompasses the particular wireless device as well as other wireless devices that also receive the broadcast signal.

The term “satellite” is often used even when a more appropriate term would be “gNB associated with the satellite”. The term “satellite” may also be called a satellite node, an NTN node, node in space, etc. Here, gNB associated with a satellite might include both a regenerative satellite, where the gNB is the satellite payload, i.e., the gNB is integrated with the satellite, or a transparent satellite, where the satellite payload is a relay and the gNB is on the ground (i.e. the satellite relays the communication between the gNB on the ground and the WD).

The time period or duration over which a WD can maintain connection, or camp on, or maintain communication with a satellite or a gNB is referred to as “coverage time” or “serving time” or “network availability” or “sojourn time” or “dwell time,” etc. The term ‘Non-coverage time’, also known as “non-serving time” or “network unavailability”, or “non-sojourn time” or “non-dwell time” refers to a period of time during which a satellite or gNB cannot serve or communicate with or provide coverage to a WD. Another way to interpret the availability of satellite or network node coverage is that whether the WD needs to measure certain satellites.

The term node may be a network node or a satellite node or a network node within a satellite or a user equipment (UE). Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc.), O&M, OSS, SON, positioning node (e.g. E-SMLC), etc.

The non-limiting term WD refers to any type of wireless device communicating with a network node and/or with another WD in a cellular or mobile communication system. Examples of WD are target device, device to device (D2D) WD, vehicular to vehicular (V2V), machine type WD, MTC WD or WD capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-IoT), Wi-Fi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as primary synchronization signal (PSS), secondary synchronization signal (SSS), channel state information reference signal (CSI-RS), demodulation reference signal (DMRS), signals in a SS/PBCH block (SSB), discovery reference signal (DRS), cell-specific reference signal (CRS), positioning reference signal (PRS) etc. A reference signal may be periodic. For example, a RS occasion carrying one or more RSs may occur with certain periodicity, e.g., 20 ms, 40 ms, etc. The RS may also be aperiodic. Each SSB carries NR-PSS, NR-SSS and NR-PBCH in 4 successive symbols. One or multiple SSBs are transmitted in one SSB burst which is repeated with certain periodicity, e.g., 5 ms, 10 ms, 20 ms, 40 ms, 80 ms and 160 ms. The WD is configured with information about SSB on cells of certain carrier frequency by one or more SS/PBCH block measurement timing configuration (SMTC) configurations. The SMTC comprising parameters such as SMTC periodicity, SMTC occasion length in time or duration, SMTC time offset with respect to a reference time (e.g., serving cell's system frame number (SFN)), etc. Therefore, SMTC occasion may also occur with certain periodicity, e.g. 5 ms, 10 ms, 20 ms, 40 ms, 80 ms and 160 ms. Examples of uplink (UL) physical signals are reference signal such as sounding reference signal (SRS), DMRS, etc. The term physical channel may refer to any channel carrying higher layer information, e.g., data, control information, etc. Examples of physical channels are PBCH, narrow band PBCH (NPBCH), PDCCH, PDSCH, sPUCCH, sPDSCH, sPUCCH, sPUSCH, MPDCCH, NPDCCH, NPDSCH, E-PDCCH, PUSCH, PUCCH, NPUSCH etc.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

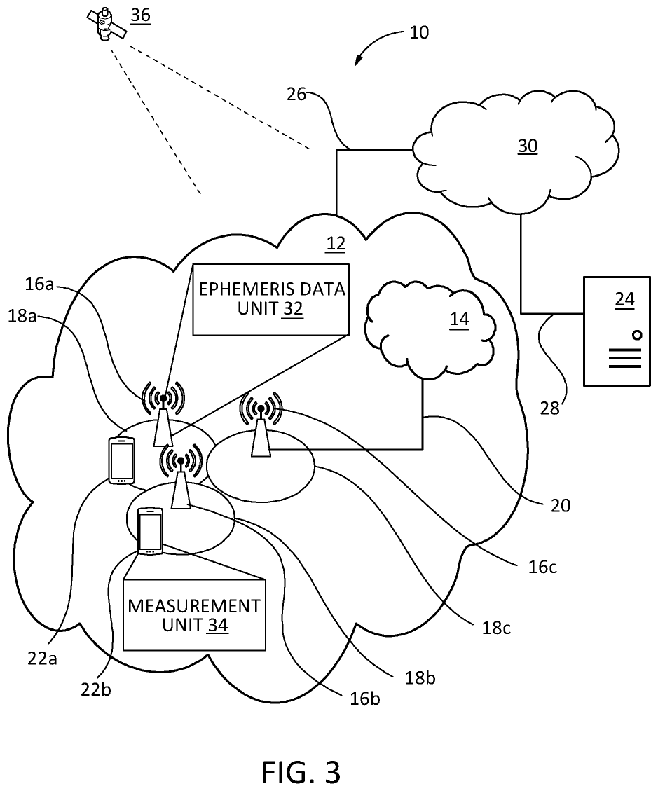

Some embodiments provide adaptive measurement procedures for intermitted and overlapping non-terrestrial network (NTN) coverage. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an ephemeris data unit 32 which is configured to determine a satellite coverage time parameter corresponding to a communication satellite in an earth orbit, the satellite coverage time parameter being based at least on ephemeris data of the communication satellite. A wireless device 22 is configured to include a measurement unit 34 which is configured to perform reference signal measurements according to timing based on a size of a footprint of the communication satellite and the determined satellite coverage time parameter.

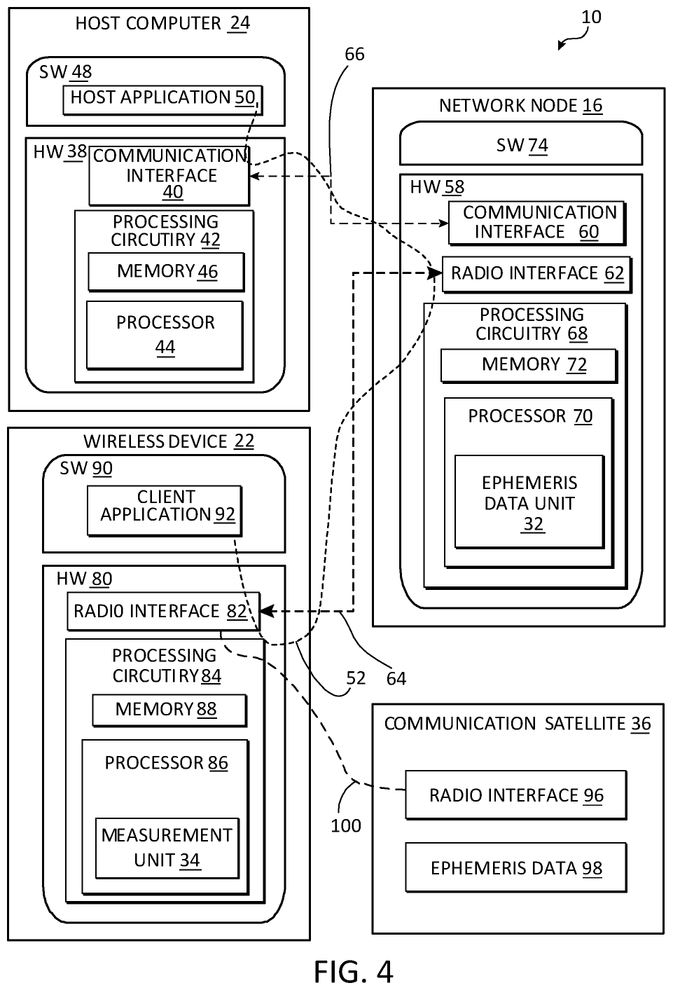

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling the network node 16 to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an ephemeris data unit 32 which is configured to determine a satellite coverage time parameter corresponding to a communication satellite in an earth orbit, the satellite coverage time parameter being based at least on ephemeris data of the communication satellite.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a measurement unit 34 which is configured to perform reference signal measurements according to timing based on a size of a footprint of the communication satellite and the determined satellite coverage time parameter.

In some embodiments, the inner workings of the network node 16, WD 22, and host computer 24 may be as shown in FIG. 3 and independently, the surrounding network topology may be that of FIG. 4.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

In an NTN, a communication satellite 36 may be in radio communication with the WD 22 via a radio link 100 between a radio interface 96 of the communication satellite 36 and the radio interface 82 of the WD 22. Although not shown in FIG. 4, there may also be a radio link between the communication satellite 36 and the network node 16. The communication satellite 36 is configured to store ephemeris data which may be transmitted to the network node 16 and/or the WD 22.

Although FIGS. 3 and 4 show various “units” such as ephemeris data unit 32, and measurement unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

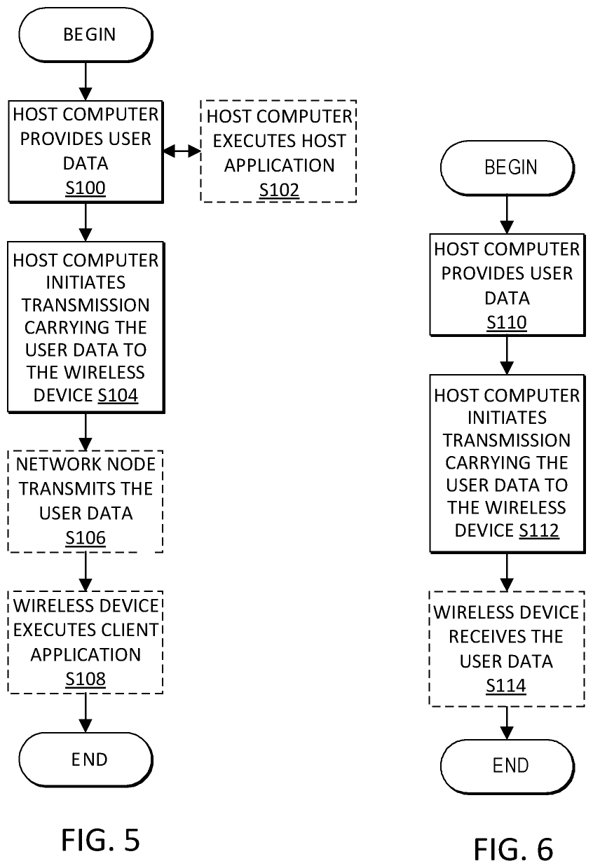

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

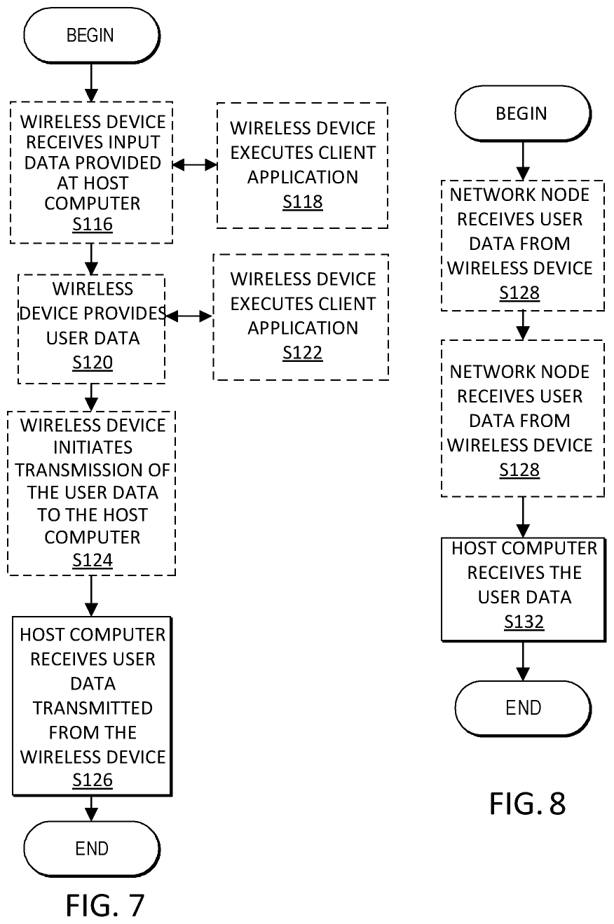

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

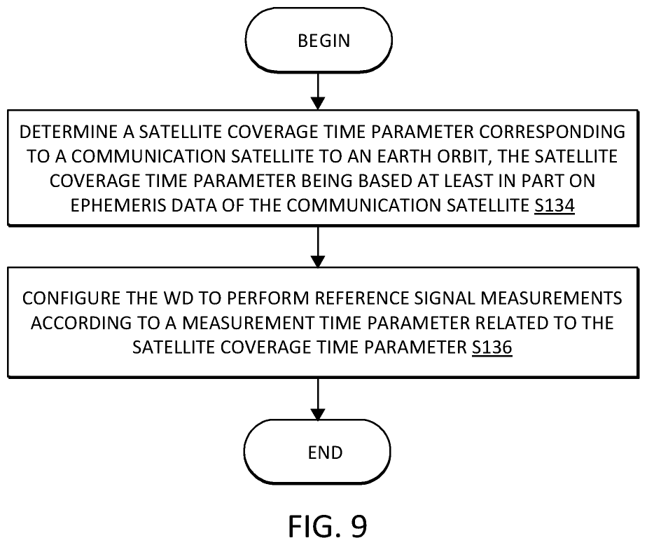

FIG. 9 is a flowchart of an example process in a network node 16 for performing adaptive measurement procedures for intermitted and overlapping non-terrestrial network (NTN) coverage. One or more blocks described herein may be performed by one or more elements of network node 16 such as by one or more of processing circuitry 68 (including the ephemeris data unit 32), processor 70, radio interface 62 and/or communication interface 60. Network node 16 such as via processing circuitry 68 and/or processor 70 and/or radio interface 62 and/or communication interface 60 is configured to determine a satellite coverage time parameter corresponding to a communication satellite 36 in an earth orbit, the satellite coverage time parameter being based at least in part on ephemeris data of the communication satellite 36 (Block S134). The process also includes configuring the WD to perform reference signal measurements according to a measurement time parameter related to the satellite coverage time parameter (Block S136).

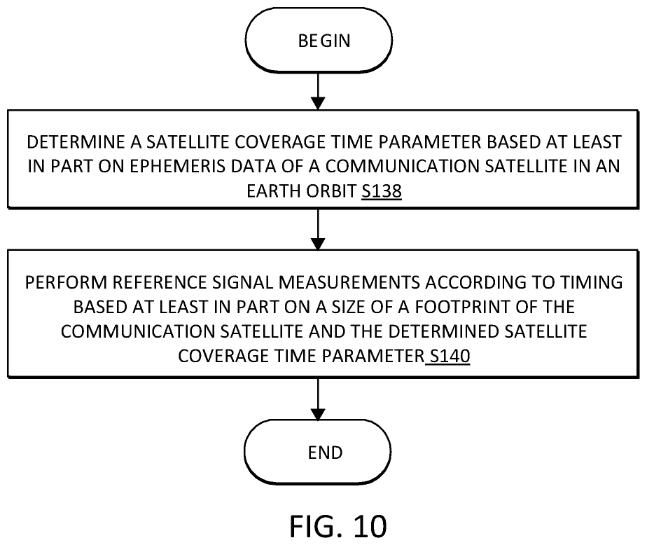

FIG. 10 is a flowchart of an example process in a wireless device 22 according to some embodiments of the present disclosure. One or more blocks described herein may be performed by one or more elements of wireless device 22 such as by one or more of processing circuitry 84 (including the measurement unit 34), processor 86, radio interface 82 and/or communication interface 60. Wireless device 22 such as via processing circuitry 84 and/or processor 86 and/or radio interface 82 is configured to determine a satellite coverage time parameter based at least in part on ephemeris data of a communication satellite 36 in an earth orbit (Block S138). The process also includes performing reference signal measurements according to timing based at least in part on a size of a footprint of the communication satellite 36 and the determined satellite coverage time parameter (Block S140).

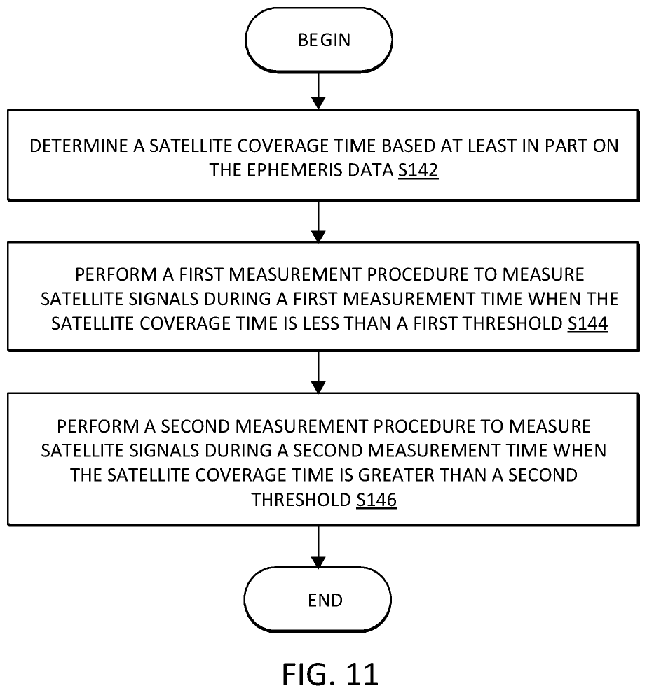

FIG. 11 is a flowchart of an example process in a wireless device 22 according to some embodiments of the present disclosure. One or more blocks described herein may be performed by one or more elements of wireless device 22 such as by one or more of processing circuitry 84 (including the measurement unit 34), processor 86, radio interface 82 and/or communication interface 60. Wireless device 22 such as via processing circuitry 84 and/or processor 86 and/or radio interface 82 is configured to determine a satellite coverage time based at least in part on the ephemeris data (Block S142). The process also includes performing a first measurement procedure to measure satellite signals during a first measurement time when the satellite coverage time is less than a first threshold (Block S144). The process further includes performing a second measurement procedure to measure satellite signals during a second measurement time when the satellite coverage time is greater than a second threshold (Block S146).

In some embodiments, the first measurement time is determined based at least in part on scaling a base time interval by a first scaling factor and the second measurement time is determined based at least in part on scaling the base time interval by a second scaling factor, the first scaling factor being less than the second scaling factor. In some embodiments, measurements of the satellite signals are performed in a first repetition pattern during the first measurement time and measurements of the satellite signals are performed in a second repetition pattern during the second measurement time. In some embodiments, the satellite coverage time is determined based at least in part on an angle of arrival of a satellite signal. In some embodiments, at least one of the first measurement time and the second measurement time excludes at least one guard window during a time of remaining satellite coverage. In some embodiments, the satellite coverage time is based at least in part on information from the network node including at least one of WD position, WD direction, and WD speed. In some embodiments, at least one of the first measurement time and the second measurement time is based at least in part on an estimate of error in the ephemeris data. In some embodiments, the first measurement procedure includes measuring satellite signals on a first number of beams and the second measurement procedure includes measuring satellite signals on a second number of beams. In some embodiments, the first measurement procedure includes measurement on a first number of reference signals and the second measurement procedure includes measurement on a second number of reference signals. In some embodiments, the method also includes sending measurement reports to the network node in a first repetition pattern during the first measurement time and sending measurement reports to the network node in a second repetition pattern during the second measurement time. In some embodiments, the first measurement time is smaller than the second time. In some embodiments, at least one of the first measurement time and the second measurement time includes at least one of a cell detection time, a measurement period of a measurement, synchronization signal block, SSB, index acquisition time, measurement reporting delay, radio link monitoring, RLM, out of sync evaluation period, RLM in sync evaluation period, beam detection evaluation period, candidate beam detection evaluation period and measurement period of L1-measurement.

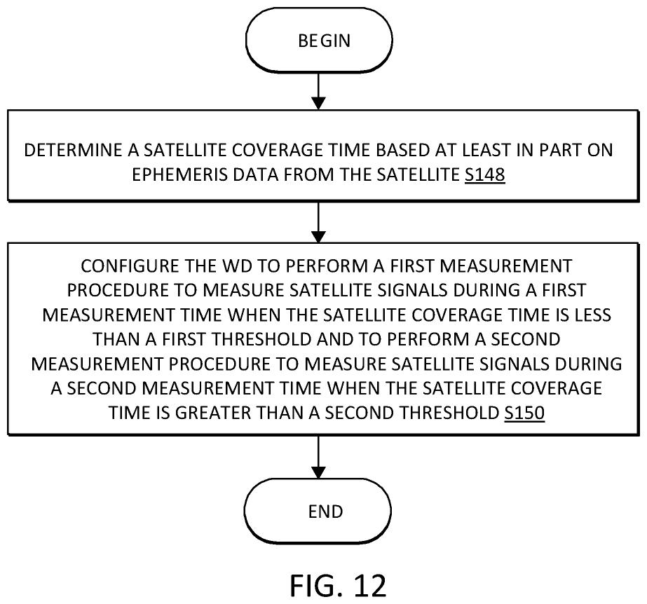

FIG. 12 is a flowchart of an example process in a network node 16 for performing adaptive measurement procedures for intermitted and overlapping non-terrestrial network (NTN) coverage. One or more blocks described herein may be performed by one or more elements of network node 16 such as by one or more of processing circuitry 68 (including the ephemeris data unit 32), processor 70, radio interface 62 and/or communication interface 60. Network node 16 such as via processing circuitry 68 and/or processor 70 and/or radio interface 62 and/or communication interface 60 is configured to determine a satellite coverage time based at least in part on ephemeris data from the satellite (Block S148). The process also includes configuring the WD to perform a first measurement procedure to measure satellite signals during a first measurement time when the satellite coverage time is less than a first threshold and to perform a second measurement procedure to measure satellite signals during a second measurement time when the satellite coverage time is greater than a second threshold (Block S150).

In some embodiments, the first measurement time is determined based at least in part on scaling a base time interval by a first scaling factor and the second measurement time is determined based at least in part on scaling the base time interval by a second scaling factor, the first scaling factor being less than the second scaling factor. In some embodiments, the method also includes configuring the WD to perform measurements of the satellite signals in a first repetition pattern during the first measurement time and to perform measurement of the satellite signals in a second repetition pattern during the second measurement time. In some embodiments, the satellite coverage time is determined based at least in part on an angle of arrival of a satellite signal at the WD. In some embodiments, the method also includes determining a plurality of satellite coverage times based at least in part on ephemeris data from a plurality of satellites and configuring the WD with a first satellite coverage time of the plurality of satellite coverage times. In some embodiments, the first measurement time is smaller than the second measurement time. In some embodiments, the first measurement time or the second measurement time comprising at least one of a cell detection time, a measurement period of a measurement, synchronization signal block, SSB, index acquisition time, measurement reporting delay, radio link monitoring, RLM, out of sync measurement time, RLM in sync measurement time, beam detection measurement time, candidate beam detection measurement time and measurement period of L1-measurement.

Having described the general process flow of arrangements of the disclosure and having provided examples of hardware and software arrangements for implementing the processes and functions of the disclosure, the sections below provide details and examples of arrangements for adaptive measurement procedures for intermitted and overlapping non-terrestrial network (NTN) coverage.

### Description of Example Scenario

For an earth-fixed cell, continuously adjusting the beam direction may introduce additional complexity in the satellite antenna system implementation. Beam steering is implementation dependent, and it is already in operation for some satellite constellations.

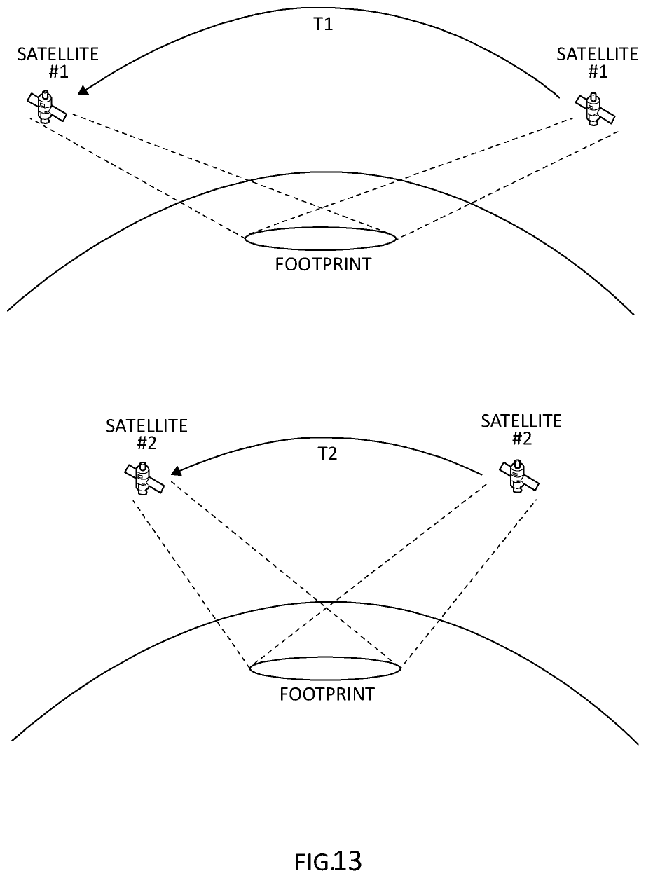

FIG. 13 shows varied coverage times of satellites in which satellite #1 has a coverage time T1 during which satellite #1 can be observed by a WD 22 and serves the WD 22, whereas satellite #2 has coverage time T2 during which satellite #2 can be observed by the WD 22 and serves the same WD 22. The timing may depend on relative geographic distance and angle between the WD 22 and ephemeris of the satellite.

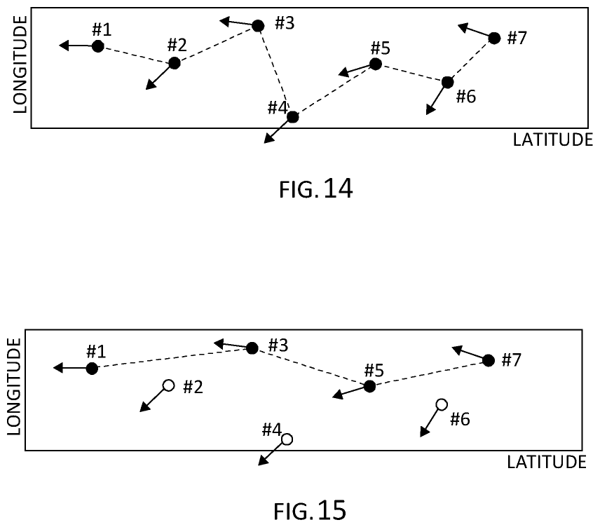

The earth-fixed cell is given here as an example to illustrate the timing, but a same behavior also occurs in an earth-moving cell and any scenario between low earth orbit and geostationary orbit. To visualize switching between satellites serving the same WD 22, FIG. 14 depicts connection switching among all available satellites, with the X-axis representing latitude and the Y-axis representing Longitude. The black dots with an arrow represent moving satellites to which the WD 22 is connected, while each dashed line shows switching between two satellites.

FIG. 14 shows an extreme example in which each available satellite is utilized, obviously resulting in a large number of mobility operations or satellite handovers, etc. Therefore, in practice, satellite switching or change in serving satellite is more likely to look like the example shown in FIG. 15. In this example the selection of target satellite to serve the WD 22 is determined by the WD 22 and/or the serving network node 16 based on a minimum number of satellite switches, while maintaining an uninterrupted connection between the WD 22 and the serving satellite, e.g., a continuous connection. There's no need for satellites #2, #4, and #6 to serve the WD 22 in the example of FIG. 15.

An example of a practical switching scheme for changing serving satellites is shown in FIG. 15, but the method can also be utilized for any other switching scheme.

### Some Example Embodiments

Some embodiments may save WD 22 power (e.g., energy, battery life, etc.) and/or reduce signaling overhead and/or minimize interruption due to link changes.

Examples of such interruptions include interruptions due to cell change (e.g., hand over (HO)), beam changes, etc. An adaptive WD 22 measurement procedure is disclosed. In some embodiments, a method in a WD 22 comprises adapting the operation of one or more signals with respect to the availability of serving satellite coverage. The term operation of a signal may comprise transmission of the signal by the WD 22 and/or reception of the signal at the WD 22. The term operating a signal may comprise WD 22 transmitting the signal and/or receiving the signal. The reception of a signal may also be called monitoring a signal, measuring a signal, etc. In one example, the measurement adaptation or adaptive measurement or adaptive measurement procedure enables the WD 22, while maintaining the connection with a satellite, to measure on signals with different rates and/or periodicities and/or over different time period in certain radio resource control (RRC) states, such as RRC IDLE state and RRC INACTIVE state. In another example, the monitoring adaptation or adaptive monitoring or adaptive monitoring procedure enables the WD 22 to monitor a downlink control channel, (for example for paging, acquiring system information, etc.), while maintaining the connection with a satellite, less frequently.

The measurement adaptation may be applied by the WD 22 by means of utilizing the knowledge of predictability of satellite coverage time.

An example measurement adaptation procedure based on the satellite coverage time is discussed below.

### Obtaining Coverage Time of Satellite

The duration of the satellite coverage (ΔT) or information related to the satellite coverage time a for certain satellite (e.g., serving satellite) may be characterized by one or more of the following parameters:
Starting reference time (Ts) is the moment when the coverage time for a satellite (e.g., a serving satellite) starts; and
Ending reference time (Te) is the moment when the coverage time for a satellite (e.g., a serving satellite) ends.

In one example, the WD 22 obtains parameters, ΔT and Ts, to determine when the coverage time starts and ends. In another example, the WD 22 obtains parameters, Te and Ts, to determine when the coverage time starts and ends. In another example, the WD 22 obtains parameters, ΔT, Te and Ts, to determine when the coverage time starts and ends.

The starting reference time, Ts, for a satellite (S2) may further comprise one or more of:
The moment when the WD 22 changes the old serving satellite (S1) to a new satellite (S2);
The moment when the WD 22 operates (e.g. transmits and/or receives) a first signal between the WD 22 and S2;
The moment determined by the WD 22 autonomously or by receiving from another node; and/or
The moment determined by the WD 22 based on a trigger condition, e.g., when the WD 22 measures a signal level (e.g., reference signal received power (RSRP), reference signal received quality (RSRQ), signal to noise ratio (SNR), signal to interference plus noise ratio (SINR), etc.) of a signal from S2 and determines that the signal level has changed by less than a certain margin (H1) within the last time period (Ts1), or when the WD 22 measured signal level of a signal from S2 is below a certain threshold (H2) within the last time period (Ts2), etc.

The ending reference time, Te, for a satellite (S2) may further comprise one or more of:
The moment when the WD 22 changes the current serving satellite (S2) to a new satellite (S3);
The moment when the WD 22 served by S2 sends a signal (e.g., random access channel (RACH)) to S3 for changing the serving satellite from S2 to S3;
The moment when the WD 22 operates (e.g., transmits and/or receives) a last signal between the WD 22 and S2;
The moment determined by the WD 22 autonomously or by receiving from another node; and/or
The moment determined by the WD 22 based on a trigger condition. Such a trigger condition may be when a signal level (e.g., RSRP, RSRQ, SNR, SINR, etc.) of a signal from S2 measured by the WD 22 has changed by more than a certain margin (H3) within the last time period (Te1). Another trigger condition may include when the signal level of a signal from S2 measured by the WD 22 is equal to above certain threshold (H4) within the last time period (Te2), etc. In one example H1≠H3 and/or H2≠H4. In another example H1=H3 and/or H2=H4.

The parameters ΔT, Te and Ts may be related by a function. Examples of such functions are difference, average, sum, ceiling, floor, product, etc. Examples include:
In one general example, ΔT=f1(Te, Ts). For example, f1(.): ΔT=Te−Ts;
In another general example, ΔT=f2(Te, δ₁, Ts, δ₂); where δ₁ and δ₂ are margins to account for timing estimation errors, etc.; and/or
   In one specific example: f2(.): ΔT={(Te−δ₁)−(Ts+δ₂)}.

The WD 22 obtains the satellite coverage time-related information (e.g., ΔT, Ts, Te, etc.) based on one or more methods described below.

In some embodiments, the WD 22 autonomously calculates and predicts potential satellite coverage time-related parameters or information, such as WD 22 acquisition of the satellite assistance information. The WD 22 may acquire the satellite assistance information by receiving it periodically and/or based on a trigger. Examples of triggers include the serving satellite changes, the measured signal from the satellite at the WD 22 changes by more than certain threshold, the system information or assistance information changes, etc. For example, the WD 22 can estimate satellite coverage time-related information using satellite assistance information, e.g., satellite ephemeris information, or any other means, e.g., broadcast information.

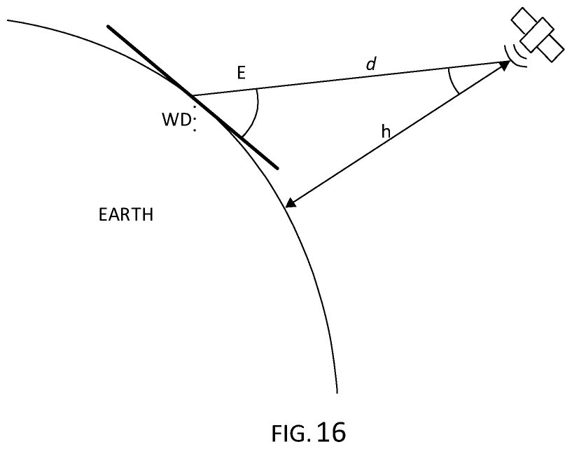

An example of the procedure in the WD 22 of autonomously determining the coverage time of a satellite based on the acquired satellite ephemeris information, is as follows:
First, the WD 22 calculates sets of mappings between satellite positions and their timings according to the acquired satellite ephemeris data;
Second, the WD 22 chooses satellite positions based on the angle ϵ which is demonstrated in the graph shown in FIG. 16). When ϵ>a predefined threshold, the satellite may be observed by the WD 22; and
Third, the WD 22 determines that the time during which the satellite will provide coverage (i.e., the satellite's coverage time) is the duration over which the satellite's angle ϵ>the predefined threshold.

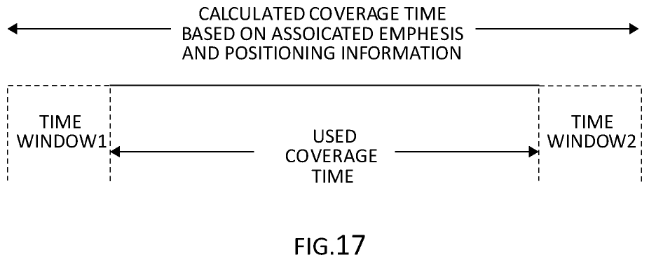

As an example, the coverage time may further account for one or more timing errors including inaccuracy of acquiring satellite ephemeris information, timing difference between two consecutive satellites to which WD 22 is connected and so on, prior to and/or after the coverage time which is represented by time window 1 and time window 2 in some embodiments, where, referring to FIG. 17:
Time window 1=Tephemeris_error1+Tdiff_satellite1+ . . .
Time window 2=Tephemeris_error1+Tdiff_satellite2+ . . .
   and where:
Tephemeris_error1 is a sum of inaccuracy in acquiring satellite ephemeris information of the previously connected satellite and inaccuracy in acquiring satellite ephemeris information of the currently connected satellite;
Tdiff_satellite1 is the timing difference between the previously connected satellite and the currently connected satellite;
Tephemeris_error2 is a sum of inaccuracy of acquiring satellite ephemeris information of the currently connected satellite and inaccuracy in acquiring satellite ephemeris information of the next or the subsequently connected satellite; and
Tdiff_satellite2 is the timing difference between the currently connected satellite and the next or the subsequently connected satellite.

In another embodiment, each satellite may transmit satellite assistance information, (e.g., satellite ephemeris information) containing information about the satellite coverage time. In this case, the WD 22 may not autonomously calculate the satellite coverage time related parameters for a satellite. The network node 16 (may estimate the coverage time parameters based on one or more of positions of the WD 22, a state of mobility of the WD 22, a mobility state of a serving satellite (e.g., speed, direction, etc.), a serving satellite's ephemeris information, measurement results for measurements by the WD 22 on serving and neighbor cells, etc. The determined coverage time related parameters may be transmitted in a message via the satellite to the WD 22. The message may be transmitted in a broadcast message such as system information and/or in a WD 22 specific message, etc.

In a typical terrestrial network, a serving cell may have information concerning neighbor cells, although how the information is acquired is not specified. Thus, the network may include system information about neighbor cells or in a WD 22 specific measurement configuration to assist the WD 22.

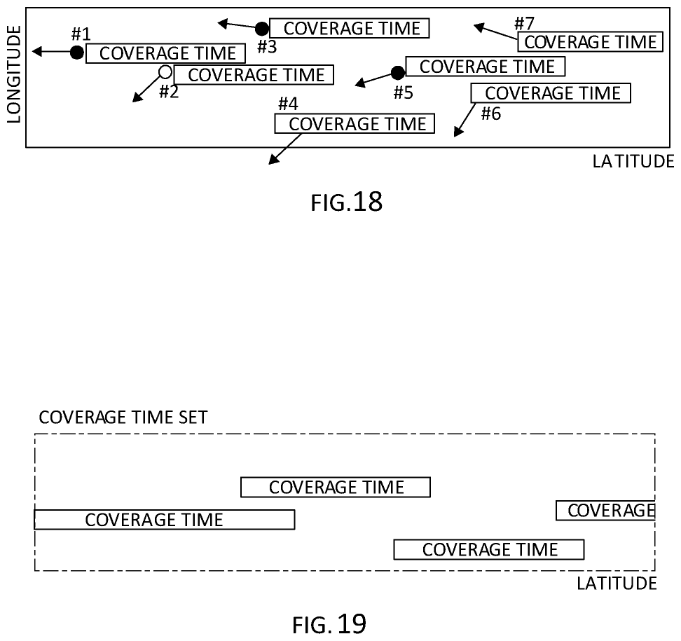

In another embodiment, coverage time can be obtained for multiple satellites, e.g., a serving satellite and one or more target satellites. The target satellites may have the potential to become the serving satellites after the currently serving satellite's coverage diminishes. The coverage times #1, #3 and #5 for satellites #1, #3 and #5 respectively, shown in FIG. 18, may be combined together to generate a coverage time set which can be treated as a long coverage time or composite coverage time, as shown in FIG. 19.

### WD Transition Between Normal State and Relaxed State Based on Criteria

The WD 22 operating signals in normal state and relaxed state may be according to different measurement procedures.

The WD 22 when in normal state evaluates one or more criteria related to one or more parameters related to the satellite coverage time. Based on the evaluation the WD 22 may switch from normal state to relaxed state, or the WD 22 may stay in the normal state. The switching between normal state and relaxed state may be called a state transition, state change, modification of state, transformation of state, etc.

Some examples of criteria that trigger the WD 22 to switch from normal state to relaxed state are described below:
In one example, the WD 22 determines a relationship between the obtained coverage time (ΔT) for a satellite with a threshold (G1). Based on the relationship, the WD 22 may switch from normal state to relaxed state, or the WD 22 may stay in the normal state while served by that satellite. Examples of relationships are comparison, ratio, difference, etc.:
   In one specific example, if (ΔT>G1) then the WD 22 switches from normal state to relaxed state; otherwise if (ΔT≤G1) then the WD 22 stays in the normal state;
In another example, the WD 22 determines a relationship between the obtained coverage time set (CT1) for a set of satellites with a threshold (G2). Based on the relationship, the WD 22 may switch from normal state to relaxed state, or the WD 22 may stay in the normal state while served by the set of satellites. Examples of relationships are comparison, ratio, difference, etc.:
   In one specific example, if (CT1>G2) then the WD 22 switches from normal state to relaxed state; otherwise if (CT1≤G2) then the WD 22 stays in the normal state;
In one example, the WD 22 may obtain coverage time (ΔT) for a satellite and/or coverage time set CT1 parameters for certain set of satellites, even before the WD 22 enters the satellite coverage area, e.g., based on prediction results.

The WD 22 when in relaxed state further evaluates one or more criteria related to one or more parameters related to the satellite coverage time. Based on the evaluation, the WD 22 may switch from relaxed state to normal state, or the WD 22 may stay in the relaxed state. Some examples of criteria triggering the WD 22 to switch from relaxed state to normal state are described below:
In one example, the WD 22 determines a relationship between a remaining coverage time (ΔT′) for a satellite with a threshold (G3). Based on the relationship, the WD 22 may switch from normal state to relaxed state, or the WD 22 may stay in the normal state while served by that satellite. Examples of relationships are comparison, ratio, difference etc. In one example, ΔT′ is the amount of the remaining coverage time determined at a certain reference time (Tc), e.g., ΔT′≤ΔT, and Tc≥Ts. For example assume that at Ts, ΔT=100 s. At a future time, Tc (where Tc=Ts+10 s), ΔT=90 s:
   In one specific example, if (ΔT′≤G3) then the WD 22 switches from relaxed state to normal state; otherwise if (ΔT′>G3) then the WD 22 stays in the relaxed state;
In another example, the WD 22 determines a relationship between the remaining coverage time set (CT1′) for a set of satellites with a threshold (G4). Based on the relationship, the WD 22 may switch from relaxed state to normal state, or the WD 22 may stay in the relaxed state while served by the set of satellites. In one example, CT1′ is the amount of the remaining coverage time determined at a certain reference time (Tc), e.g., CT1′≤CT1. For example, assume that at Ts, CT1=200 s. At a future time, Tc (where Tc=Ts+50 s), ΔT=150 s:
   In one specific example, if (CT1′≤G4) then the WD 22 switches from relaxed state to normal state; otherwise if (CT1′>G4) then the WD 22 stays in the relaxed state;
In another example, the WD 22 may switch from relaxed state to normal state based on a relationship between one or more signal levels (e.g. RSRP, RSRQ, SNR, SINR, path loss, etc.) measured on satellite signals and their respective thresholds. The WD 22 may measure the signal levels periodically or when one or more conditions are met, e.g., after expiry of a timer which may start when the last measurement was performed, or when the WD 22 entered a relaxed state, etc. For example, based on the measured signal levels the WD 22 may determine whether the satellite coverage has been suddenly changed, e.g., the WD 22 is moving towards a corner of building, which obstructs the serving satellite from providing good and stable coverage. For example, if the measured signal level has changed by more than X dB in the last Tx time period, then the WD 22 may revert to normal state; otherwise the WD 22 may stay in the relaxed state.
In the above examples the one or more parameters, G1, G2, G3, G4 may be pre-defined or configured by the network node 16.

### WD Measurement Procedures in Normal State and Relaxed State

The WD 22 in normal state operates signals between the WD 22 and a satellite according to a legacy measurement procedure or legacy procedure or legacy operating procedure. The legacy procedure is called a first procedure or first measurement procedure (P1). The WD 22 when operating signals based on the first procedure, meet reference requirements. The reference requirements may also be called legacy requirements or requirements without relaxation. The WD 22 may perform measurement, acquire SI, perform paging, etc., while meeting reference requirements.

Examples of requirements are measurement time, measurement accuracy, number of identified cells to measure per carrier, number of beams (e.g., SSBs) to measure, etc. Examples of measurement time are cell detection time, measurement period of a measurement (e.g., SS-RSRP, SS-RSRQ, SS-SINR, etc.), SSB index acquisition time, measurement reporting delay, radio link monitoring (RLM) evaluation period. An measurement time may be one of an out of synchronization evaluation period, an in synchronization evaluation period, a beam detection evaluation period, a candidate beam detection evaluation period, measurement period of L1-measurement (e.g., L1-RSRP, L1-SINR, etc.), etc.

The WD 22 in a relaxed state operates signals between the WD 22 and a satellite according to a relaxed measurement procedure or relaxed procedure or relaxed operating procedure. The relaxed procedure is called a second procedure or a second measurement procedure (P2). The WD 22 when operating signals based on the second procedure, may meet relaxed requirements. The relaxed requirements are less stringent than the reference requirements, e.g., performing measurements, acquiring SI, paging, etc., while meeting relaxed requirements.

Some differences between the WD 22 measurement procedures in normal state and relaxed state are described with several examples below:
In the relaxed state, the WD 22 may perform measurement less frequently in one of the following ways, for example: not measure in every SMTC window occasion but only every Kth SMTC occasion, K=2 or 3 or 4, etc. In the normal state, the WD 22 may measure every Lth SMTC occasion where L<K. When the WD 22 knows it does not have to detect and measure N SSBs but only M, the WD 22 may still get equally good measurement results with less effort. Here N>M. Thresholds for N or M can be pre-defined or configured for when the WD 22 can enter the relaxed measurement mode;
In the relaxed state, the WD 22 may choose to measure on fewer beams (e.g., SSBs) compared to the number of beams measured in normal state;
In the relaxed state, the WD 22 is allowed to perform measurements according to one or more of the following mode of operations:
   The WD 22 performs measurements while meeting relaxed requirements, e.g., longer or extended measurement time (Tme) as compared to a reference measurement time (Tmr). In one example, Tme=K*Tmr; where K>1. In another example, Tme=1600 ms while Tmr=400 ms for the same measurement e.g. SS-RSRP;
   The WD 22 performs measurements less frequently than in a normal measurement state of operation;
   The WD 22 performs measurements over a longer period of time than in the relaxed measurement mode;
   The WD 22 performs measurements with an accuracy worse than in the normal measurement mode;
   The WD 22 performs measurements on fewer cells than in the normal measurement mode;
   The WD 22 performs measurements on fewer reference signals than in the normal measurement mode;
   The WD 22 performs measurements while meeting a requirement which is less stringent than a reference requirement; and/or
   The WD 22 transmits measurement reports to a network node 16 less frequently than in the normal measurement mode;
In general the measurement performed by the WD 22 when operating in normal mode meets reference requirements (e.g., reference measurement time) which are more stringent than the requirements (e.g., extended measurement time) met by the WD 22 for the measurement performed when operating in relaxed measurement mode.
   In some embodiments, one or more scaling factors are defined and set differently for normal state and relaxed state. The scaling factor can be used in determining a measurement time for mobility, for example. The WD 22 may perform measurements over the measurement time scaled by the scaling factor.

An example is shown in Table 2, where a scaling factor can be one of two different values in normal state and in relaxed state. In this example, M1<M2. For example, the WD 22 performs a measurement in a normal state over Tn=M1*Tb, while the WD 22 performs the same type of measurement in a relaxed state over Tr=M2*Tb, where Tb is the basic measurement time. In one example, M1=1 and M2=4 and Tb=500 ms.

TABLE 2
An example of measurement scaling factors

| | Normal state | Relaxed state |
|---|---|---|
| Scaling | M1 | M2 |
| factor | | |

In another example, the scaling factor is adjustable, e.g., in a direction proportional to length of coverage time or coverage time set. In Table 3, f (M1, CT1) is a function of M1 and CT1. In this example M1<f3(M1, CT1). For example, the WD 22 may perform a measurement in a normal state over Tn=M1*Tb, while the WD 22 may perform the same type of measurement in a relaxed state over Tr=f3(M1, CT1)*Tb, where Tb is the basic measurement time. In one example, M1=1 and f3(M1, CT1)=8 and Tb=500 ms.

TABLE 3
Another example of measurement scaling factors

| | Normal state | Relaxed state with CT1 |
|---|---|---|
| Scaling | M1 | f3(M1, CT1) |
| factor | | |

### Method in Network of Controlling WD Measurement States

In one embodiment, the step of “UE transition between normal state and relaxed state” mentioned above may be permitted by the NTN.

For example, the network node 16 (e.g., serving network node such as a gNB) may decide whether to enable the WD 22 in multiple states for measurements (normal and relaxed), because measurement relaxation may be impacted by conditional handover (CHO) characteristics. For example, more frequent changes of serving satellite brings shorter coverage time of satellite and less benefit of WD's relaxed mode. It may be beneficial for the network to decide to enable the possibility of relaxed measurement based on entire system information.

In another example, the network node 16 may transmit a threshold (H5) associated with satellite coverage time (ΔT). The WD 22 may then be allowed to enter the relaxed mode only if the satellite coverage time is larger than H5; otherwise the WD 22 does not enter in the relaxed mode. In another example, the network node 16 may transmit a threshold (H6) associated with the remaining satellite coverage time (ΔT′). The WD 22 may then be allowed to enter the relaxed mode only if the remaining satellite coverage time is larger than H6; otherwise the WD 22 does not enter in the relaxed mode. In yet another example, when the WD 22 is in RRC connected state, the network node 16 may enable a relaxed state by transmitting an indicator (allowed to relax based on coverage time) to WD 22 by radio resource control (RRC) signaling, downlink control information (DCI) or medium access control (MAC) control element (CE)). Once the WD 22 receives a command, the WD 22 can transit between normal state and relaxed state according to criteria described above. In another example, when WD 22 is in RRC idle/inactive state, WD 22 can continue to evaluate coverage time and may transit between normal state and relaxed state.

According to one aspect, a network node 16 is configured to communicate with a wireless device (WD) 22. The network node 16 includes a radio interface 62 and/or processing circuitry 68 configured to: determine a satellite coverage time parameter corresponding to a communication satellite 36 in an earth orbit, the satellite coverage time parameter being based at least in part on ephemeris data of the communication satellite 36; and configure the WD 22 to perform reference signal measurements according to a measurement time parameter related to the satellite coverage time parameter.

According to this aspect, in some embodiments, the ephemeris data is received from the satellite via the WD 22. In some embodiments, the satellite coverage time parameter is a satellite coverage time during which a footprint of the communication satellite 36 is expected to encompass the WD 22. In some embodiments, the satellite coverage time is determined based at least in part on at least one of WD 22 position, WD 22 mobility information, and reference signal measurements by the WD 22. In some embodiments, the satellite coverage time parameter is based at least in part on ephemeris data of a plurality of communication satellites 94. In some embodiments, the measurement time parameter related to the satellite coverage time parameter is at least one of a measurement repetition rate and a measurement duration.

According to another aspect, a method implemented in a network node 16 includes: determining a satellite coverage time parameter corresponding to a communication satellite 36 in an earth orbit, the satellite coverage time parameter being based at least in part on ephemeris data of the communication satellite 36; and configuring the WD 22 to perform reference signal measurements according to a measurement time parameter related to the satellite coverage time parameter.

According to this aspect, in some embodiments, the ephemeris data is received from the satellite via the WD 22. In some embodiments, the satellite coverage time parameter is a satellite coverage time during which a footprint of the communication satellite is expected to encompass the WD 22. In some embodiments, the satellite coverage time is determined based at least in part on at least one of WD 22 position, WD 22 mobility information, and reference signal measurements by the WD 22. In some embodiments, the satellite coverage time parameter is based at least in part on ephemeris data of a plurality of communication satellites 94. In some embodiments, the measurement time parameter related to the satellite coverage time parameter is at least one of a measurement repetition rate and a measurement duration.

According to yet another aspect, a WD 22 is configured to communicate with a network node 16. The WD 22 includes a radio interface 82 and/or processing circuitry 84 configured to: determine a satellite coverage time parameter based at least in part on ephemeris data of a communication satellite 36 in an earth orbit; and perform reference signal measurements according to timing based at least in part on a size of a footprint of the communication satellite 36 and the determined satellite coverage time parameter.

According to this aspect, in some embodiments, the satellite coverage time parameter is a satellite coverage time during which a footprint of the communication satellite 36 is expected to encompass the WD 22. In some embodiments, a rate of performing the reference signal measurements is based at least in part on an angle formed by a ray from the WD 22 to the communication satellite 36. In some embodiments, a duration of performing a reference signal measurement is based at least in part on an angle formed by a ray from the WD 22 to the communication satellite 36. In some embodiments, the timing is based at least in part on a comparison of a satellite coverage time to a threshold. In some embodiments, the timing is based at least in part on a comparison of a set of satellite coverage times with a threshold. In some embodiments, the timing is based at least in part on a remaining satellite coverage time. In some embodiments, the timing is based at least in part on a comparison of a reference signal measurement to a threshold. In some embodiments, in a normal state, the WD 22 performs reference signal measurements according to a first rate and in a relaxed state, the WD 22 performs reference signal measurements according to a second rate slower than the first rate. In some embodiments, in the normal state, a duration of a reference signal measurement is less than a duration of a reference signal measurement in the relaxed state.

According to another aspect, a method implemented in a WD 22 includes: determining a satellite coverage time parameter based at least in part on ephemeris data of a communication satellite 36 in an earth orbit; and performing reference signal measurements according to timing based at least in part on a size of a footprint of the communication satellite 36 and the determined satellite coverage time parameter.

According to this aspect, in some embodiments, the satellite coverage time parameter is a satellite coverage time during which a footprint of the communication satellite 36 is expected to encompass the WD 22. In some embodiments, a rate of performing the reference signal measurements is based at least in part on an angle formed by a ray from the WD 22 to the communication satellite 36. In some embodiments, a duration of performing a reference signal measurement is based at least in part on an angle formed by a ray from the WD 22 to the communication satellite 36. In some embodiments, the timing is based at least in part on a comparison of a satellite coverage time to a threshold. In some embodiments, the timing is based at least in part on a comparison of a set of satellite coverage times with a threshold. In some embodiments, the timing is based at least in part on a remaining satellite coverage time. In some embodiments, the timing is based at least in part on a comparison of a reference signal measurement to a threshold. In some embodiments, in a normal state, the method includes performing reference signal measurements according to a first rate and in a relaxed state, performing reference signal measurements according to a second rate slower than the first rate. In some embodiments, in the normal state, a duration of a reference signal measurement is less than a duration of a reference signal measurement in the relaxed state.

Some embodiments may include one or more of the following:

Embodiment A1. A network node configured to communicate with a wireless device (WD), the network node configured to, and/or comprising a radio interface and/or comprising processing circuitry configured to:
determine a satellite coverage time parameter corresponding to a communication satellite in an earth orbit, the satellite coverage time parameter being based at least in part on ephemeris data of the communication satellite; and
configure the WD to perform reference signal measurements according to a measurement time parameter related to the satellite coverage time parameter.

Embodiment A2. The network node of Embodiment A1, wherein the ephemeris data is received from the satellite via the WD.

Embodiment A3. The network node of any of Embodiments A1 and A2, wherein the satellite coverage time parameter is a satellite coverage time during which a footprint of the communication satellite is expected to encompass the WD.

Embodiment A4. The network node of any of Embodiments A1-A3, wherein the satellite coverage time is determined based at least in part on at least one of WD position, WD mobility information, and reference signal measurements by the WD.

Embodiment A5. The network node of any of Embodiments A1-A4, wherein the satellite coverage time parameter is based at least in part on ephemeris data of a plurality of communication satellites.

Embodiment A6. The network node of any of Embodiments, A1-A5, wherein the measurement time parameter related to the satellite coverage time parameter is at least one of a measurement repetition rate and a measurement duration.

Embodiment B1. A method implemented in a network node, the method comprising:
determining a satellite coverage time parameter corresponding to a communication satellite in an earth orbit, the satellite coverage time parameter being based at least in part on ephemeris data of the communication satellite; and
configuring the WD to perform reference signal measurements according to a measurement time parameter related to the satellite coverage time parameter.

Embodiment B2. The method of Embodiment B1, wherein the ephemeris data is received from the satellite via the WD.

Embodiment B3. The method of any of Embodiments B1 and B2, wherein the satellite coverage time parameter is a satellite coverage time during which a footprint of the communication satellite is expected to encompass the WD.

Embodiment B4. The method of any of Embodiments B1-B3, wherein the satellite coverage time is determined based at least in part on at least one of WD position, WD mobility information, and reference signal measurements by the WD.

Embodiment B5. The method of any of Embodiments B1-B4, wherein the satellite coverage time parameter is based at least in part on ephemeris data of a plurality of communication satellites.

Embodiment B6. The method of any of Embodiments, B1-B5, wherein the measurement time parameter related to the satellite coverage time parameter is at least one of a measurement repetition rate and a measurement duration.

Embodiment C1. A wireless device (WD) configured to communicate with a network node, the WD configured to, and/or comprising a radio interface and/or processing circuitry configured to:
determine a satellite coverage time parameter based at least in part on ephemeris data of a communication satellite in an earth orbit; and
perform reference signal measurements according to timing based at least in part on a size of a footprint of the communication satellite and the determined satellite coverage time parameter.

Embodiment C2. The WD of Embodiment C1, wherein the satellite coverage time parameter is a satellite coverage time during which a footprint of the communication satellite is expected to encompass the WD.

Embodiment C3. The WD of any of Embodiments C1 and C2, wherein a rate of performing the reference signal measurements is based at least in part on an angle formed by a ray from the WD to the communication satellite.

Embodiment C4. The WD of any of Embodiments C1 and C2, wherein a duration of performing a reference signal measurement is based at least in part on an angle formed by a ray from the WD to the communication satellite.

Embodiment C5. The WD of any of Embodiments C1-C4, wherein the timing is based at least in part on a comparison of a satellite coverage time to a threshold.

Embodiment C6. The WD of any of Embodiments C1-C4, wherein the timing is based at least in part on a comparison of a set of satellite coverage times with a threshold.

Embodiment C7. The WD of any of Embodiments C1-C4, wherein the timing is based at least in part on a remaining satellite coverage time.

Embodiment C8. The WD of any of Embodiments C1-C4, wherein the timing is based at least in part on a comparison of a reference signal measurement to a threshold.

Embodiment C9. The WD of any of Embodiments C1-C4, wherein, in a normal state, the WD performs reference signal measurements according to a first rate and in a relaxed state, the WD performs reference signal measurements according to a second rate slower than the first rate.

Embodiment C10. The WD of Embodiment C9, wherein, in the normal state, a duration of a reference signal measurement is less than a duration of a reference signal measurement in the relaxed state.

Embodiment D1. A method implemented in a wireless device (WD), the method comprising:
determining a satellite coverage time parameter based at least in part on ephemeris data of a communication satellite in an earth orbit; and
performing reference signal measurements according to timing based at least in part on a size of a footprint of the communication satellite and the determined satellite coverage time parameter.

Embodiment D2. The method of Embodiment D1, wherein the satellite coverage time parameter is a satellite coverage time during which a footprint of the communication satellite is expected to encompass the WD.

Embodiment D3. The method of any of Embodiments D1 and D2, wherein a rate of performing the reference signal measurements is based at least in part on an angle formed by a ray from the WD to the communication satellite.

Embodiment D4. The method of any of Embodiments D1 and D2, wherein a duration of performing a reference signal measurement is based at least in part on an angle formed by a ray from the WD to the communication satellite.

Embodiment D5. The method of any of Embodiments D1-D4, wherein the timing is based at least in part on a comparison of a satellite coverage time to a threshold.

Embodiment D6. The method of any of Embodiments D1-D4, wherein the timing is based at least in part on a comparison of a set of satellite coverage times with a threshold.

Embodiment D7. The method of any of Embodiments D1-D4, wherein the timing is based at least in part on a remaining satellite coverage time.

Embodiment D8. The method of any of Embodiments D1-D4, wherein the timing is based at least in part on a comparison of a reference signal measurement to a threshold.

Embodiment D9. The method of any of Embodiments D1-D4, wherein, in a normal state, the method includes performing reference signal measurements according to a first rate and in a relaxed state, performing reference signal measurements according to a second rate slower than the first rate.

Embodiment D10. The method of Embodiment D9, wherein, in the normal state, a duration of a reference signal measurement is less than a duration of a reference signal measurement in the relaxed state.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G 5th Generation
BS Base Station
CHO Conditional Handover
eNB Evolved NodeB (LTE base station)
GEO Geostationary Orbit
gNB Base station in NR.
GNSS Global Navigation Satellite System
HO Handover
LEO Low Earth Orbit
LTE Long Term Evolution
MAC Medium Access Control
NR New Radio
NTN Non-Terrestrial Network
RAT Radio Access Technology
RRC Radio Resource Control
RRM Radio Resource Management
RS Reference Signal
RSRP Reference Signal Received Power
SMTC SSB Measurement Timing Configuration
SNR Signal to noise ratio
UE User Equipment
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device (WD), the WD configured to perform measurements on satellite signals received from a satellite and receive ephemeris data from at least one of the satellite and a network node, the method comprising:
determining a satellite coverage time based at least in part on the ephemeris data;
performing a first measurement procedure to measure satellite signals during a first measurement time when the satellite coverage time is less than a first threshold; and
performing a second measurement procedure to measure satellite signals during a second measurement time when the satellite coverage time is greater than a second threshold.

2. The method of claim 1, wherein the first measurement time is determined based at least in part on scaling a base time interval by a first scaling factor and the second measurement time is determined based at least in part on scaling the base time interval by a second scaling factor, the first scaling factor being less than the second scaling factor.

3. The method of claim 1, wherein measurements of the satellite signals are performed in a first repetition pattern during the first measurement time and measurements of the satellite signals are performed in a second repetition pattern during the second measurement time.

4. The method of claim 1, wherein the satellite coverage time is determined based at least in part on an angle of arrival of a satellite signal.

5. The method of claim 1, wherein at least one of the first measurement time and the second measurement time excludes at least one guard window during a time of remaining satellite coverage.

6. The method of claim 1, wherein the satellite coverage time is based at least in part on information from the network node including at least one of WD position, WD direction, and WD speed.

7. The method of claim 1, wherein at least one of the first measurement time and the second measurement time is based at least in part on an estimate of error in the ephemeris data.

8. The method of claim 1, wherein the first measurement procedure includes measuring satellite signals on a first number of beams and the second measurement procedure includes measuring satellite signals on a second number of beams.

9. The method of claim 1, wherein the first measurement procedure includes measurement on a first number of reference signals and the second measurement procedure includes measurement on a second number of reference signals.

10. The method of claim 1, further comprising sending measurement reports to the network node in a first repetition pattern during the first measurement time and sending measurement reports to the network node in a second repetition pattern during the second measurement time.

11. The method of claim 1, wherein the first measurement time is smaller than the second time.

12. The method of claim 1, wherein at least one of the first measurement time and the second measurement time includes at least one of a cell detection time, a measurement period of a measurement, synchronization signal block, (SSB), index acquisition time, measurement reporting delay, radio link monitoring, (RLM) out of sync evaluation period, RLM in sync evaluation period, beam detection evaluation period, candidate beam detection evaluation period and measurement period of L1-measurement.

13. A wireless device (WD) configured to perform measurements on satellite signals received from a satellite, the WD being further configured to receive ephemeris data from at least one of the satellite and a network node, the wireless device comprising processing circuitry configured to:
determine a satellite coverage time based at least in part on the ephemeris data;
perform a first measurement procedure to measure satellite signals during a first measurement time when the satellite coverage time is less than a first threshold; and
perform a second measurement procedure to measure satellite signals during a second measurement time when the satellite coverage time is greater than a second threshold.

14. The WD of claim 13, wherein the first measurement time is determined based at least in part on scaling a base time interval by a first scaling factor and the second measurement time is determined based at least in part on scaling the base time interval by a second scaling factor, the first scaling factor being less than the second scaling factor.

15. The WD of claim 13, wherein measurements of the satellite signals are performed in a first repetition pattern during the first measurement time and measurements of the satellite signals are performed in a second repetition pattern during the second measurement time.

16. The WD of claim 13, wherein the satellite coverage time is determined based at least in part on an angle of arrival of a satellite signal.

17. The WD of claim 13, wherein at least one of the first measurement time and the second measurement time excludes at least one guard window during a remaining time of satellite coverage.

18. The WD of claim 13, wherein the satellite coverage time is based at least in part on information from the network node including at least one of WD position, WD direction, and WD speed.

19. The WD of claim 13, wherein at least one of the first measurement time and the second measurement time is based at least in part on an estimate of error in the ephemeris data.

20-24. (canceled)

25. A method in a network node configured to communicate with a satellite and a wireless device (WD), the method comprising:
determining a satellite coverage time based at least in part on ephemeris data from the satellite; and
configuring the WD to perform a first measurement procedure to measure satellite signals during a first measurement time when the satellite coverage time is less than a first threshold and to perform a second measurement procedure to measure satellite signals during a second measurement time when the satellite coverage time is greater than a second threshold.

26-38. (canceled)
